(19) United States
(12) Patent Application Publication
(10) Pub. No.: US 2007/0136953 A1
(43) Pub. Date: Jun. 21, 2007

(54) Stability for coapplication

(76) Inventors: Joyce M. Materniak, Hockessin, DE (US); Edward P. Carey, Atglen, PA (US); Patrick Henry Fitzgerald, Pitman, NJ (US); Melea Rena Langley, Ringgold, GA (US); Peter Michael Murphy, Chadds Ford, PA (US); Aaron Frank Self, Ringgold, GA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/312,066

(22) Filed: Dec. 20, 2005

(51) Int. Cl. C11D 3/00

(52) U.S. Cl. 8/115.51

(57) ABSTRACT

A composition comprising a stable mixture of at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof, is disclosed.

### BACKGROUND OF THE INVENTION

The present invention is generally directed to compositions and methods for simultaneous treatment of fibrous substrates with soil resist and stain resist agents. The invention is more particularly directed to chemical enhancers that permit otherwise incompatible mixtures of soil resist and stain resist agents to form stable and effective dual-purpose compositions.

Fluoropolymers that are available in the form of anionically, cationically, or nonionically dispersed fluorinated polymer emulsions are commonly used as soil resist agents for fibrous substrates, such as carpets, rugs, and textiles. Such soil resist agents act by providing water- and oil-repellency and soil resistance to treated substrates. Resistance to acid dye stains such as food and beverage stains is provided by solutions of hydrolyzed maleic anhydride copolymers, copolymers of methacrylic acid and esters thereof, or sulfonated phenolic resins and blends thereof. An example of a food and beverage stain is the acid dye stain FD&C Red #40, commonly used in beverages.

It is desirable that the soil resist agent and stain resist agent can be applied simultaneously to the fibrous substrate from a diluted aqueous mixed solution in a treatment bath. It is also desirable to have a coapplication mixture containing a cationically dispersed soil resist agent and a stain resist agent. In addition, it is desirable to have a concentrated, single-package product, containing concentrated soil resist agent plus concentrated stain resist agent to deliver to manufacturing locations. However, such mixtures of stain resist agent and soil resist agent are inherently incompatible.

Payet, et al., in U.S. Pat. No. 4,875,901, disclosed the use of divalent metal salts, such as magnesium salts, to stabilize fluorochemical oil and water repellents and stain resist resins in the treatment bath. However, as noted by Pacifici in U.S. Pat. No. 6,616,856, Payet's single step process did not gain commercial acceptance, primarily due to inconsistent water and oil repellency effectiveness and its consequent failure to meet carpet industry standards. The inconsistency resulted from the stain-resist's tendency to interfere with the fluorochemical soil resist curing process, a thermal reorientation of the fluorochemical molecules. Pacifici substituted a naphthalene-sulfonated salt as a fluorochemical anti-coalescing agent in a single bath process. Pacifici did not address the use of cationically dispersed fluorochemical-based repellent emulsions (as a soil resist agent) in combination with stain resists.

There is a need for new “coapplication enhancers” to allow for stain resist agent plus soil resist agent in aqueous dilutions to be applied using a stable single application bath. There is also a need for a single bath composition that includes a cationically dispersed soil resist agent. Additionally, there is a need for a stable concentrated mixture of stain resist agent plus soil resist agent that is directly available to mills and obviates the need for multiple component additions for application or sequential treatment processes.

Therefore, a single bath including a composition comprising mixed soil resist agent and stain resist agent that meets industry performance standards for soil and stain resistance heretofore achieved only through separate bath or sequential addition (“tandem”) processes remains a desired objective since a single bath would result in significant savings in labor, time and equipment resources. This invention provides a single coapplication composition and a single bath process method for the simultaneous application of soil resist agent and stain resist agent to carpets and other fibrous substrates.

Absent the soluble coapplication enhancers, any combination of soil resist and stain resist would not be compatible in a single bath. The coapplication enhancers of the present invention solve the problem of coapplication stability for stain and soil resist combinations, each component of which imparts excellent performance attributes to a substrate to which it is applied. Such combinations of stain and soil resist could not previously be co-applied to carpets or other fibrous substrates.

### SUMMARY OF THE INVENTION

The present invention comprises a composition comprising a stable mixture of at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids;

cyclic imide of C₂ to C₆ alkandioic acids; C₃ to C₆ lactams, or combinations thereof.

The present invention further comprises a method for providing stain resistance and soil resistance to substrates comprising contacting the substrate with a single medium containing a stable mixture comprising at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof.

The present invention further comprises a substrate to which has been applied from a single medium a composition comprising a stable mixture of at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof.

### DETAILED DESCRIPTION

Herein trade names and trademarks are shown in upper case.

By the use herein of the term “stain resist” is meant a stain resist agent comprising a composition for application to a substrate to reduce staining by acid dye stains, such as food and beverage stains. By the use herein of the term “soil resist” is meant a soil resist agent comprising a composition for application to a substrate to reduce soiling and provide repellency.

The term “coapplication enhancer” is used herein to mean an additive that is mixed with the soil resist and stain resist agents in the composition of the present invention to provide a stable mixture.

The present invention comprises a stable mixture comprising (a) at least one stain resist, (b) at least one soil resist, and (c) at least one coapplication enhancer. The coapplication enhancer comprises at least one of a salt, an aryl sulfonic acid, urea, an amide, an imide, or a lactam. The stable mixture is in the form of a solution, a dispersion, or a combination of solution and dispersion.

Suitable coapplication enhancers for use in the stable mixture of the present invention comprise one or more of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imides of C₂ to C₆ alkandioic acids; C₃ to C₆ lactams, or combinations thereof.

Suitable amides include the amides, alkylamides, dialkylamides, and cyclic amides of formic acid, of C₁ to C₆ alkanoic acids, and of C₁ to C₆ alkandioic acids. Examples include formamide, caprolactam, malonamide, acetamide, dimethylacetamide, dimethylformamide, succinamide, succinimide, malonimide, and other similar amides. Each coapplication enhancer comprising an amide as set forth above has a typical molecular weight of less than about 200 grams/mole, are water soluble, and are neither strongly acidic nor strongly basic.

When the coapplication enhancer is a salt, the salt is a cation in combination with an anion selected from the group consisting of a sulfate, sulfonate, sulfite, phosphate, borate, chloride, polyphosphate, nitrate, acetate, citrate, benzoate, tetrafluoroborate, tartrate, phthalate, and mono and dialkyl phosphate. Suitable aryl salts are sulfonated aromatic compounds containing from about 6 to about 10 carbon atoms, optionally with alkyl substituents. Preferred aryl sulfonates include sodium aryl sulfonate, potassium aryl sulfonate, sodium toluene sulfonate, and sodium xylene sulfonate. The aryl sulfonates are added as the free sulfonic acids, e.g., p-toluenesulfonic acid, or as their alkali metal salts, preferably the sodium salt. Divalent metal salts, as magnesium sulfate, disclosed by Payet in U.S. Pat. No. 4,875,901, are ineffective as coapplication enhancers.

Preferred coapplication enhancers include aryl sulfonate, acetamide, dimethylacetamide, formamide, dimethylformamide, caprolactam, malonamide, malonimide, succinamide, or succinimide. More preferred coapplication enhancers include sodium sulfate, potassium sulfate, trisodium phosphate, sodium aryl sulfonate, potassium aryl sulfonate, sodium phosphate, and toluene sulfonic acid. Preferably the coapplication enhancer is water-soluble.

Soil resist agents suitable for use in the composition of the present invention are commercially available and comprise fluorinated polyurethanes, a polymer or copolymer containing fluorinated acrylates or a polymer or copolymer containing fluorinated methacrylates. The preferred soil resist agents contain perfluoroalkyl groups of the following formula R_{f}(CH₂)ₙ-wherein R_{f} is a straight or branched perfluoroalkyl having from about 2 to about 20 carbon atoms, (n is an integer of 1 to about 20) or a mixture thereof, where the perfluoroalkyl is optionally interrupted by at least one oxygen atom. Perfluoroalkyl groups wherein n is about 4 to about 10 are preferred. The polymeric fluorochemical soil resist is anionically, cationically, or nonionically dispersed. Fluorochemical soil resists for application to fibrous substrates such as carpets, rugs, and textiles are commercially available from, but not limited to, E. I. du Pont de Nemours and Company, 3M, Daikin, Clariant, and Asahi. Commercially available soil resists, other soil resists known in the art, as well as combinations of these, are suitable for use in the present invention.

One example of a preferred soil resist is a polymeric fluorochemical soil resist that is cationically dispersed and prepared as claimed in U.S. Pat. No. 6,790,905, herein incorporated by reference. Preferred coapplication enhancers for a composition of the invention comprising this soil resist are sodium sulfate, sodium xylene sulfonate, sodium acetate, sodium phosphate, sodium chloride, sodium tetraborate, trisodium phosphate, urea and combinations thereof including, but not limited to, sodium sulfate and urea or sodium acetate and urea. An additional preferred soil resist is an anionically dispersed fluorinated polyurethane soil resist prepared according to Example 8 in U.S. Pat. No. 5,414,111, herein incorporated by reference.

Commercially available stain resist agents, other stain resist agents known in the art, or combination s thereof, are suitable for use in the present invention. These comprise a sulfonated phenolic resin or condensate; a partially sulfonated novalac resin; a polymer or copolymer of acrylic acid, methacrylic acid or esters thereof; a hydrolyzed copolymer of maleic anhydride with olefin or vinyl ether; a hydrolyzed ethylenically unsaturated aromatic/maleic anhydride copolymer; and combinations thereof. Examples are disclosed in U.S. Pat. Nos. 5,851,595 and 6,613,862, each herein incorporated by reference.

Particular examples of these preferred classes of stain resist agents include dispersions of a mixture of hydrolyzed maleic anhydride copolymers, sulfonated phenolic resins, and surfactants, prepared as in U.S. Pat. Nos. 4,883,839; 4,948,650 and 5,032,136, each herein incorporated by reference. In particular, mixtures of a hydrolyzed ethylenically unsaturated aromatic/maleic anhydride copolymer, or a hydrolyzed copolymer of an olefin or a vinyl ether with maleic anhydride are preferred. Also preferred is a dispersion of a mixture of hydrolyzed maleic anhydride copolymers, sulfonated phenolic resin, aqueous solution of a partial salt of a hydrolyzed octene/maleic anhydride copolymer, and surfactant as disclosed in U.S. Pat. No. 5,654,068, herein incorporated by reference, as well as mixtures of hydrolyzed maleic anhydride copolymers and sulfonated phenolic resins, or mixtures of hydrolyzed octene/maleic anhydride copolymers and sulfonated phenolic resins.

Another preferred stain resist agent is a dispersion of a sulfonated phenol-formaldehyde condensation product as disclosed and prepared as in U.S. Pat. No. 4,833,009. Other suitable stain resist agents for use herein include 1) hydrolyzed vinyl aromatic-maleic anhydride copolymers and hydrolyzed styrene maleic anhydride copolymers as disclosed in U.S. Pat. No. 5,096,747; 2) those described in U.S. Pat. No. 5,460,887 comprising hydrolyzed styrene/maleic anhydride copolymers; 3) partially sulfonated novalac resins as disclosed in U.S. Pat. No. 4,875,901 and European Patent 797699; 4) those disclosed in U.S. Pat. No. 5,712,348 comprising maleic acid copolymers with fluorinated thioether end-caps; 5) those disclosed in U.S. Pat. No. 6,238,792 comprising maleic acid terpolymers; and 6) combinations thereof. Each of the seven patents recited above in this paragraph are herein incorporated by reference.

In the composition of the present invention, the ratio of coapplication enhancer to a combination of stain resist agent and soil resist agent is from about 1:4 to about 1:52 on a 100% solids weight basis, preferably from about 1:6 to about 1:40 on a 100% solids weight basis, and more preferably from about 1:8 to about 1:32 on a 100% solids weight basis.

Other surface effect treatment agents may be applied simultaneously with the stable composition of the present invention, or sequentially to the fibrous substrate. Such additional components comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, odor control, antimicrobial, sun protection, and similar effects. One or more such treating agents or finishes can be combined with the composition of the present invention and applied to the fibrous substrate. Other additives commonly used with such treating agents or finishes may also be present such as surfactants, sequestering agents, leveling agents, pH adjusters, cross linkers, blocked isocyanates, hydrocarbon extenders, wetting agents, wax extenders, and other additives known by those skilled in the art. Suitable surfactants include anionic, cationic, nonionic, and amphoteric.

The present invention further comprises a method of providing stain resistance and soil repellency to fibrous substrates comprising contacting the substrate with a single medium containing a stable mixture comprising a stain resist agent, a soil resist agent, and a coapplication enhancer as described above. The fibrous substrate is passed through the application apparatus and the stain resist and soil resist are exhausted or deposited onto the fabric from a single application medium, such as a bath, containing the composition of the present invention. The present invention includes the use of a mixture of the stain resist agent, soil resist agent, and coapplication enhancer, optionally with other additives, in a bath or other treatment medium. The composition is applied to the fibrous substrate in a process such as an exhaustion, for example a Beck or Winch method, or by use of other conventional application methods known in the art. These include continuous methods such as, but not limited to, Flex-nip, pad, spray, or foam application. Continuous methods of application can include steaming after application of the composition of the present invention.

The components of the present invention are added separately or as a premix to a bath or other treatment or contacting medium. A preferred sequence of addition is the salt (pre-dissolved in water), followed by the stain resist and soil resist, and then pH adjustment. The stain resist should not be mixed with the soil resist or vice versa before the coapplication enhancer solution has been added. Optionally, as noted above, other conventional additives may be added to the composition or treatment medium, such as chemicals to adjust pH (for instance urea sulfate, or other acid), sequestering agents (such as ethylene diamine tetraacetic acid), additional surfactants, leveling agents, and the like.

Conventional bath conditions can be used for the contacting medium. For example, for an exhaust application, an application period of from about 5 minutes to about 30 minutes and preferably about 20 minutes is employed. The bath to fiber weight ratio is from about 40:1 to about 2:1. The bath pH is from about 1 to about 9, preferably about 1.5 to about 5.0, and more preferably about 1.8 to about 3.0. The bath temperature is from about 160° F. to about 200° F. (from about 71° C. to about 93° C.), and preferably about 190° F. (about 88° C.). Lower pH and higher temperature improve exhaust efficiency but the more extreme conditions may adversely affect equipment. These conditions are balanced with operating and maintenance costs. After application of the composition of the present invention to the substrate, the fibrous substrate is rinsed and dried conventionally.

The amount of coapplication enhancer present in the contacting medium for application to a substrate is from about 0.05 g/L to about 2 g/L, preferably from about 0.1 g/L to about 1.7 g/L, and more preferably from about 0.2 g/L to about 1.5 g/L. The amount of mixture (composition of the present invention) contacting the substrate is from about 0.1 to about 5 percent solids on weight of fiber, preferably from about 0.3 to about 4% solids on weight of fiber, and more preferably from about 0.5 to about 3% solids on weight of fiber.

The present invention further comprises a substrate treated with the composition of the present invention as disclosed above. Most any fibrous substrate is suitable for treatment by the compositions and methods of the present invention. Such substrates include fibers, yams, fabrics, fabric blends, textiles, carpet, rugs, nonwovens, leather and paper. The term “fiber” includes fibers and yams, before and after spinning, of a variety of compositions and forms, and includes pigmented fibers and pigmented yams. By “fabrics” is meant natural or synthetic fabrics, or blends thereof, composed of fibers such as cotton, rayon, silk, wool, polyester, polypropylene, polyolefins, nylon, and aramids such as “NOMEX” and “KEVLAR.” By “fabric blends” is meant fabric made of two or more different fibers. Typically these blends are a combination of at least one natural fiber and at least one synthetic fiber, but also can be a blend of two or more natural fibers and/or of two or more synthetic fibers. Carpets, for example, can be made of cotton, wool, silk, nylon, acrylics, aromatic polyamides, polyesters, jute, sisal, and other cellulosics.

The compositions and methods of the present invention are useful to provide stain resistance and soil repellency to fibrous substrates in a single application step with a single stable coapplication composition. The treated substrates maintain excellent resistance to acid dye stains and soiling over time. The compositions of the present invention are useful on a variety of fibrous substrates such as carpets, textiles, and fabrics benefiting consumers in multiple usage situations. The coapplication enhancers of the present invention solve the problem of coapplication stability for stain and soil resist combinations that provide excellent performance attributes.

### MATERIALS AND TEST METHODS

The following materials and test methods were used in the Examples set forth below.

Soil Resist 1 is a cationically dispersed fluorinated polyurethane soil resist prepared according to U.S. Pat. No. 6,790,905 and available from E. I. du Pont de Nemours and Company, Wilmington Del.

Soil resist 2 is an anionically-dispersed fluorinated polyurethane soil resist prepared according to Example 8 in U.S. Pat. No. 5,414,111, available from E. I. du Pont de Nemours and Company, Wilmington Del.

Soil Resist 3 is a cationically dispersed fluorinated polyurethane soil resist prepared according to U.S. Pat. No. 6,790,905 and available from E. I. du Pont de Nemours and Company, Wilmington Del.

Stain Resist 1 is a blend of hydrolyzed maleic anhydride copolymers or terpolymers, sulfonated phenolic resin, and an aqueous solution of a partial sodium salt of a hydrolyzed octene/maleic anhydride copolymer prepared according to U.S. Pat. No. 5,654,068.

Stain Resist 2 is a blend of hydrolyzed maleic anhydride copolymers or terpolymers and sulfonated phenolic resin, prepared according to U.S. Pat. No. 4,948,650 and U.S. Pat. No. 5,032,136, and commercially available from E. I. du Pont de Nemours and Company, Wilmington, Del.

Stain Resist 3 is a blend of an aqueous solution of a partial sodium salt of a hydrolyzed octene/maleic anhydride copolymer and sulfonated phenolic resin, prepared according to U.S. Pat. No. 5,654,068, and commercially available from E. I. du Pont de Nemours and Company, Wilmington, Del.

Stain Resist 4 is a blend of sulfonated phenolic resin and an aqueous solution of a partial sodium salt of a hydrolyzed octene/maleic anhydride copolymer.

Stain Resist 5 is FX-668F, a product from 3M, which is based on poly(methacrylic acid). 3M, Minneapolis, Minn.

Stain Resist 6 is a blend of sulfonated phenolic resin and hydrolyzed maleic anhydride copolymers or terpolymers.

Carpet substrates are described in the Examples.

Test Method 1—Cherry KOOL-AID Stain Test Method

Cherry KOOL-AID (KOOL-AID is a trademark of Kraft General Foods, Inc., White Plains N.Y.) stain testing was conducted on carpet samples 15 cm by 15 cm. Acid dye stain resistance was evaluated using a procedure based on the American Association of Textile Chemists and Colorists (AATCC) Method 175, “Stain Resistance: Pile Floor Coverings.” A staining solution was prepared by mixing sugar sweetened cherry KOOL-AID (36.5 g) and 500 mL water. The carpet sample to be tested was placed on a flat non-absorbent surface and a hollow plastic cylinder having a 2-inch (5-cm) diameter was placed tightly over the carpet sample. KOOL-AID staining solution (20 mL) was poured into the cylinder, which had been previously placed on the carpet sample. Gently work the stain into the carpet. The cylinder was then removed and the stained carpet sample was allowed to sit undisturbed for 24 hours. Then the carpets were rinsed thoroughly under cold tap water for at least 10 minutes until the rinse water was clear. The carpet samples were extracted, and air-dried for 24 hours on a non-absorbent surface. The KOOL-AID stains obtained by this procedure were rated either with a visual stain rating scale (AATCC Red 40 Stain Scale) from AATCC Test Method 175 or using a measurement of delta E color difference. A visual rating of 10 (complete stain removal) to 1 (maximum or unchanged stain) was obtained by using the AATCC Red 40 Stain Scale (Test Method #175) with the KOOL-AID stains having the same discoloration as the numbered colored film.

Test Method 2—Water Repellency

Water repellency was measured according to AATCC Test Method 193. Higher values indicate increased water repellency.

Test Method 3—Oil Repellency

Oil repellency was measured according to AATCC Test Method 118. Higher values indicate increased oil repellency.

Test Method 4—Mixture Stability

All mixtures of stain resist, soil resist, and coapplication enhancer were judged as stable (i.e., the formulation remains a homogeneous mixture) or unstable (i.e., the formulation is not a homogeneous mixture) by visual observation after storage periods as indicated in each Example and Comparative Example.

### EXAMPLES

Examples are denoted by numerals, Comparative Examples by letters. The amount of stain resist, coapplication enhancer, and soil resist in each Example and Comparative Example totaled 100%.

### Examples 1-5

Concentrated mixtures were prepared for Examples 1-5 by physically mixing 50% of the mixture consisting of Stain Resist 1, 25% of a 10% coapplication enhancer solution as listed in Table 1, and 25% of Soil Resist 1. The mixtures were observed for stability after three and five days (Test Method 4). Stability results are listed in Table 1.

### Comparative Example A

A concentrated mixture was prepared for Comparative Example A by physically mixing 66.7% of the mixture consisting of Stain Resist 1, and 33.3% of Soil Resist 1, but no coapplication enhancer. The mixture was observed for stability after three and five days (Test Method 4). Stability results are listed in Table 1.

### Comparative Examples B and C

Concentrated mixtures were prepared for Comparative Examples B and C by physically mixing 50% of Stain Resist 1, 25% of a 10% salt solution as listed in Table 1, and 25% of Soil Resist 1. The mixtures were observed for stability after three and five days (Test Method 4). Stability results are listed in Table 1.

TABLE 1

| | Stain | Coapplication | Soil | | |
|---|---|---|---|---|---|
| | Resist | enhancer 25% | Resist | Stability | |
| Ex. # | 50% | (as 10% solution) | 25% | 3 days | 5 days |
| 1 | Stain | Sodium xylene | Soil | Stable | Stable |
| | Resist 1 | sulfonate | Resist 1 | | |
| 2 | Stain | Monosodium | Soil | Stable | Stable |
| | Resist 1 | phosphate | Resist 1 | | |
| 3 | Stain | Sodium acetate | Soil | Stable | Stable |
| | Resist 1 | | Resist 1 | | |
| 4 | Stain | Sodium chloride | Soil | Stable | Stable |
| | Resist 1 | | Resist 1 | | |
| 5 | Stain | Sodium tetraborate | Soil | Stable | Stable |
| | Resist 1 | | Resist 1 | | |
| A | Stain | None | Soil | Unstable | Unstable |
| | Resist 1 | | Resist 1 | | |
| B | Stain | Magnesium sulfate | Soil | Unstable | Unstable |
| | Resist 1 | | Resist 1 | | |
| C | Stain | 2-Naphthalene | Soil | Unstable | Unstable |
| | Resist 1 | sulfonic acid | Resist 1 | | |

As shown in Table 1, Examples 1-5, concentrated mixtures of Stain Resist 1. Soil Resist 1, coapplication enhancers as 10% solutions of sodium xylene sulfonate, monosodium phosphate, sodium acetate, sodium chloride, and sodium tetraborate respectively and were stable. Comparative Example A, which contained Stain Resist 1 and Soil Resist 1, with no coapplication enhancer, was not stable. Comparative Example B, which contained Stain Resist 1, 10% magnesium sulfate solution, and Soil Resist 1 was not stable. Comparative Example C, which contained Stain Resist 1, 10% 2-naphthalene sulfonic acid solution, and Soil Resist 1 was not stable.

### Example 6

A concentrated mixture was prepared for Example 6 by physically mixing 50% of Stain Resist 4, 25% of a 10% coapplication enhancer solution as listed in Table 2, and 25% of Soil Resist 1. The mixture was observed for stability after one and twenty-one days (Test Method 4). Stability results are listed in Table 2.

### Comparative Example D

A concentrated mixture was prepared for Comparative Example D by physically mixing 66.7% of Stain Resist 4, 33.3% Soil Resist 1, but no coapplication enhancer. The mixture was observed for stability after one and twenty-one days (Test Method 4). Stability results are listed in Table 2.

### Comparative Example E

A concentrated mixture was prepared for Comparative Example E by physically mixing 50% of Stain Resist 4, 25% of a 10% solution of magnesium sulfate, and 25% of Soil Resist 1. The mixture was observed for stability after one and twenty-one days (Test Method 4). Stability results are listed in Table 2.

TABLE 2

| | | Coapplication | | | |
|---|---|---|---|---|---|
| | | enhancer | Soil | | |
| | Stain Resist | 25% (as | Resist | Stability | |
| Ex. # | 50% | 10% solution) | 25% | 1 day | 21 days |
| 6 | Stain Resist 4 | Trisodium | Soil | Stable | Stable |
| | | phosphate | Resist 1 | | |
| D | Stain Resist 4 | None | Soil | Unstable | Unstable |
| | | | Resist 1 | | |
| E | Stain Resist 4 | Magnesium | Soil | Unstable | Unstable |
| | | sulfate | Resist 1 | | |

As shown in Table 2, Example 6, the concentrated mixture of Stain Resist 4, a coapplication enhancer containing a 10% solution of trisodium phosphate, and Soil Resist 1 was stable. Comparative Example D, which contained Stain Resist 4, Soil Resist 1, but no coapplication enhancer, was not stable.

Comparative Example E, which contained Stain Resist 4, 10% magnesium sulfate solution, and Soil Resist 1 was not stable.

### Example 7

A concentrated mixture was prepared for Example 7 by physically mixing 60% of Stain Resist 4, 20% of a 10% coapplication enhancer solution as listed in Table 3, and 20% of Soil Resist 1. The mixture was observed for stability after one and twenty days (Test Method 4). Stability results are listed in Table 3.

The composition was applied to carpet to simulate a continuous application. Carpet used for this application was 45 oz/yd² (1.53 kg/m²) beige nylon 6,6 residential cut-pile carpet. Each carpet sample was saturated with water and then most of the water in the carpet was removed by mechanical means (such as by spin-drying or vacuum extraction) until the weight of the water remaining in the carpet sample was about 20% to about 40% of the dry carpet weight.

One part of the concentrated mixture was diluted with 83 parts water to prepare an application bath. The pH of the application bath was adjusted to 2.0 using 30% sodium bisulfate solution. The application was done with 500% wet pick-up to deliver 0.9% on weight of fiber of the composition (on a 100% solids basis). The mixture was evenly applied to the wetted carpet samples and manually worked into the carpet until the substrate was fully saturated. The carpet samples were placed in a single layer on the bottom of a microwave-safe plastic tray with the pile side up. A lid, with punctured vents to prevent steam build-up, was placed on top of the plastic tray.

The carpets were microwaved until the temperature reached 195° F. (91° C.) at power level 10, and held at 195° F. (91° C.) for 2 minutes. A household microwave oven with a temperature probe (General Electric model JVM 1660 available from General Electric, Schenectady N.Y.) was used to monitor the temperature. The carpets were thoroughly rinsed with water. Most of the water in the carpet sample was removed by spin-drying with an extractor until the weight of water remaining in the carpet was about 20-40% of the dry carpet weight. This was followed by oven drying at 180° F. (82° C.) for 20 minutes, then oven curing at 280° F. (138° C.) for 3-4 minutes. The carpet samples were allowed to cool completely and to reach equilibrium with the room environment prior to proceeding with testing.

The carpet sample was tested for stain resistance by Test Method 1 (24 hour KOOL-AID stain test). Water and oil repellencies were evaluated by Test Methods 2 and 3 (AATCC test methods 193 and 118). Stain and repellency results are shown in Table 3.

### Comparative Example F

Comparative Example F was an untreated carpet of the same substrate that was used to prepare Example 7. Carpet samples were tested for stain resistance with Test Method 1. Water and oil repellencies were evaluated by Test Methods 2 and 3. Stain and repellency results are shown in Table 3.

TABLE 3

| | Stain | Coapplication | Soil | | | | |
|---|---|---|---|---|---|---|---|
| | Resist | enhancer 20% | Resist | Stability | | Stain | Water/oil |
| Ex. # | 60% | (as 10% solution) | 20% | 1 day | 20 days | Resistance | repellency |
| 7 | Stain | Monosodium | Soil | Stable | Stable | 9.5 | 5/1 |
| | Resist 4 | phosphate | Resist 1 | | | | |
| F | None | None | None | N/A | N/A | 1 | 0/0 |

N/A, not applicable.

As shown in Table 3, Example 7, the concentrated mixture of Stain Resist 4, a coapplication enhancer as a 10% salt solution of monosodium phosphate, and Soil Resist 1 was stable, and the composition delivered performance benefits of stain resistance and repellency to the carpet.

### Example 8

A concentrated mixture was prepared for Example 8 by physically mixing 60% of Stain Resist 4, 20% of a coapplication enhancer containing 10% salt solution as listed in Table 4, and 20% of Soil Resist 1. The mixtures were observed for stability after one and twenty days (Test Method 4). Stability results are listed in Table 4. One part of the concentrated mixture was diluted with 49 parts water to prepare an application bath. The pH of the application bath was adjusted to 2.0 with Autoacid A-10 (from Peach State Laboratories, Rome Ga.).

Carpet used for this application was light blue nylon 6,6 residential cut-pile carpet. The composition was applied to carpet by an exhaust method with 25:1 bath to fiber ratio. The composition was applied to the carpet in a quantity to provide 1.0% on weight of fiber (on a 100% solids basis). The application bath and carpet were brought up to the temperature of 190° F. (88° C.) and held for 20 minutes. Then the sample was rinsed and centrifuged. The carpet was oven cured at 280° F. (138° C.) for 3 minutes. The carpet sample was tested for stain resistance using Test Method 1. Repellency was evaluated by Test Methods 2 and 3. Results are in Table 4.

### Comparative Example G

Comparative Example G was an untreated carpet of the same substrate as was used to prepare Example 8. It was evaluated for water and oil repellency using Test Methods 2 and 3. Results are in Table 4.

TABLE 4

| | Stain | Coapplication | Soil | | | | |
|---|---|---|---|---|---|---|---|
| | Resist | enhancer 20% | Resist | Stability | | Stain | Water/oil |
| Ex. # | 60% | (as 10% solution) | 20% | 1 day | 20 days | Resistance | repellency |
| 8 | Stain | Monosodium | Soil | Stable | Stable | 10 | 5/5 |
| | Resist 4 | phosphate | Resist 1 | | | | |
| G | None | None | None | N/A | N/A | ND | 0/0 |

N/A, not applicable.
ND, not determined.

As shown in Table 4 the concentrated mixture of Stain Resist 4, a coapplication enhancer solution containing 10% salt solution of monosodium phosphate, and Soil Resist 1 was stable, and the composition delivered performance benefits of stain resistance and repellency to the carpet.

### Examples 9-23

Concentrated mixtures were prepared for Examples 9-23 by physically mixing 50% of Stain Resist 1, 25% of a 10% coapplication enhancer containing a salt solution as listed in Table 5, and 25% of Soil Resist 2. The mixtures were observed for stability after three and five days (Test Method 4). Stability results are listed in Table 5.

### Comparative Example H

A concentrated mixture was prepared for Comparative Example H by physically mixing 67.7% of Stain Resist 1 and 33.3% of Soil Resist 2, but no coapplication enhancer, and observed for stability after three and five days (Test Method 4). Stability results are listed in Table 5.

### Comparative Examples I and J

Concentrated mixtures were prepared for Comparative Examples I and J by physically mixing 50% of Stain Resist 1, 25% of a 10% salt or acid solution as listed in Table 1, and 25% of Soil Resist 2. The mixtures were observed for stability after three and five days (Test Method 4). Stability results are listed in Table 5.

TABLE 5

| | | Coapplication | | | |
|---|---|---|---|---|---|
| | Stain Resist | enhancer 25% (as 10% | | Stability | |
| Ex. # | 50% | solution) | Soil Resist 25% | 3 days | 5 days |
| 9 | Stain Resist 1 | Sodium sulfate | Soil | Stable | Stable |
| | | | Resist 2 | | |
| 10 | Stain Resist 1 | p-Toluene sulfonic | Soil | Stable | Stable |
| | | acid | Resist 2 | | |
| 11 | Stain Resist 1 | Sodium xylene | Soil | Stable | Stable |
| | | sulfonate | Resist 2 | | |
| 12 | Stain Resist 1 | Urea | Soil | Stable | Stable |
| | | | Resist 2 | | |
| 13 | Stain Resist 1 | Potassium sulfate | Soil | Stable | Stable |
| | | | Resist 2 | | |
| 14 | Stain Resist 1 | Lithium sulfate | Soil | Stable | Stable |
| | | | Resist 2 | | |
| 15 | Stain Resist 1 | Ammonium sulfate | Soil | Stable | Stable |
| | | | Resist 2 | | |
| 16 | Stain Resist 1 | Sodium sulfite | Soil | Stable | Stable |
| | | | Resist 2 | | |
| 17 | Stain Resist 1 | Sodium acetate | Soil | Stable | Stable |
| | | | Resist 2 | | |
| 18 | Stain Resist 1 | Dipotassium L-tartrate | Soil | Stable | Stable |
| | | | Resist 2 | | |
| 19 | Stain Resist 1 | Disodium L-tartrate | Soil | Stable | Stable |
| | | | Resist 2 | | |
| 20 | Stain Resist 1 | Sodium chloride | Soil | Stable | Stable |
| | | | Resist 2 | | |
| 21 | Stain Resist 1 | Sodium p-toluene | Soil | Stable | Stable |
| | | sulfonate | Resist 2 | | |
| 22 | Stain Resist 1 | Dipotassium phthalate | Soil | Stable | Stable |
| | | | Resist 2 | | |
| 23 | Stain Resist 1 | Sodium tetraborate | Soil | Stable | Stable |
| | | | Resist 2 | | |
| H | Stain Resist 1 | None | Soil | Unstable | Unstable |
| | | | Resist 2 | | |
| I | Stain Resist 1 | Magnesium sulfate | Soil | Unstable | Unstable |
| | | | Resist 2 | | |
| J | Stain Resist 1 | 2-Naphthalene | Soil | Unstable | Unstable |
| | | sulfonic acid | Resist 2 | | |

As shown in Table 5, concentrated mixtures of Stain Resist 1, Soil Resist 2, and a coapplication enhancer containing 10% salt solutions of sodium sulfate, p-toluene sulfonic acid, sodium xylene sulfonate, urea, potassium sulfate, lithium sulfate, ammonium sulfate, sodium sulfite, sodium acetate, dipotassium L-tartrate, disodium L-tartrate, sodium chloride, sodium p-toluene sulfonic acid, dipotassium phthate, and sodium tetraborate respectively and were stable. Comparative Example H, which contained Stain Resist 1, Soil Resist 2, and no coapplication enhancer, was not stable. Comparative Example I, which contained Stain Resist 1, a 10% salt solution of magnesium sulfate, and Soil Resist 2 was not stable. Comparative Example J, which contained Stain Resist 1, a 10% solution of 2-naphthalene sulfonic acid, and Soil Resist 2 was not stable.

### Example 24

A concentrated mixture was prepared for Example 24 by physically mixing 50% of Stain Resist 1, 25% of a 10% coapplication enhancer solution as listed in Table 6, and 25% of Soil Resist 2. The mixture was observed for stability after one and twenty days (Test Method 4). Stability results are listed in Table 6. One part of the concentrated mixture was diluted with 49 parts water to prepare an application bath. The pH of the application bath was adjusted to 2.0 using Autoacid A-10. Carpet used for this application was light blue nylon 6,6 residential cut-pile carpet The composition was applied to carpet by an exhaust method with 25:1 bath to fiber ratio. The composition was applied to the carpet in a quantity to provide 1.3% on weight of fiber (on a 100% solids basis). The application bath and carpet were brought up to the temperature of 190° F. (88° C.) and held for 20 minutes. Then the sample was rinsed and centrifuged. The carpet was oven cured at 280° F. (138° C.) for 3 minutes. The carpet sample was tested for stain resistance with Test Method 1. Repellency was evaluated by Test Methods 2 and 3. Results are listed in Table 6.

### Comparative Example K1

Comparative Example K1 was an untreated carpet of the same substrate that was used to prepare Example 24. It was tested using Test Methods 1, 2 and 3. Results are in Table 6.

TABLE 6

| | Stain | Coapplication | Soil | | | | |
|---|---|---|---|---|---|---|---|
| | Resist | enhancer 25% | Resist | Stability | | Stain | Water/oil |
| Ex. # | 50% | (as 10% solution) | 25% | 1 day | 20 days | Resistance | repellency |
| 24 | Stain | p-Toluene | Soil | Stable | Stable | 10 | 4/1 |
| | Resist 1 | sulfonic acid | Resist 2 | | | | |
| K1 | None | None | None | N/A | N/A | 1 | 0/0 |

N/A, not applicable

As shown in Table 6, the concentrated mixture of Stain Resist 1, a 10% coapplication enhancer solution of p-toluene sulfonic acid, and Soil Resist 2 was stable, and the composition delivered performance benefits of stain resistance and repellency to the carpet.

### Example 25

A concentrated mixture was prepared for Example 25 by physically mixing 50% of Stain Resist 4, 25% of a 10% solution containing coapplication enhancers as listed in Table 7, and 25% of Soil Resist 2. The mixture was observed for stability after one and twenty days (Test Method 4). Stability results are listed in Table 7. One part of the concentrated mixture was diluted with 49 parts water to prepare an application bath. The pH of the application bath was adjusted to 2.0 using Autoacid A-10. Carpet used for this application was light blue nylon 6,6 residential cut-pile carpet. The composition was applied to carpet by an Ahiba exhaust method with 25:1 bath to fiber ratio. The composition was applied to the carpet in a quantity to provide 1.2% on weight of fiber (on a 100% solids basis). The application bath and carpet were brought up to the temperature of 190° F. (88° C.) and held for 20 minutes. Then the sample was rinsed and centrifuged. The carpet was oven cured at 280° F. (138° C.) for 3 minutes. The carpet sample was tested for stain resistance with the Test Method 1. Repellency was evaluated by Test Methods 2 and 3. Results are in Table 7.

### Comparative Example K2

Comparative Example K2 was an untreated carpet of the same substrate that was used to prepare Example 25. It was tested using Test Methods 1, 2 and 3. Results are in Table 7.

### Comparative Example L

Comparative Example L was prepared by physically mixing 50% Stain Resist 4, 23% of a 10% salt solution of magnesium sulfate, and 25% of Soil Resist 2. The mixture was observed for stability at 1 and 20 days using Test Method 4. Results are in Table 7.

TABLE 7

| | | Coapplication | | | | | |
|---|---|---|---|---|---|---|---|
| | Stain | enhancer 25% | | | | | |
| | Resist | (as 10% | Soil Resist | Stability | | Stain | Water/oil |
| Ex. # | 50% | solution) | 25% | 1 day | 20 days | Resistance | repellency |
| 25 | Stain | p-Toluene | Soil | Stable | Stable | 9.5 | 4/3 |
| | Resist 4 | sulfonic acid | Resist 2 | | | | |
| L | Stain | Magnesium | Soil | Unstable | Unstable | N/A | N/A |
| | Resist 4 | sulfate | Resist 2 | | | | |
| K2 | None | None | None | N/A | N/A | 1 | 0/0 |

N/A, not applicable.

As shown in Table 7, the concentrated mixture of Stain Resist 4, a 10% coapplication enhancer solution containing p-toluene sulfonic acid, and Soil Resist 2 was stable, and the composition delivered performance benefits of stain resistance and repellency to the carpet. Comparative Example L was unstable.

### Example 26

A concentrated mixture was prepared for Example 26 by physically mixing 50% of Stain Resist 3, 25% of a 10% coapplication enhancer solution as listed in Table 8, and 25% of Soil Resist 2. The mixture was observed for stability after one and twenty days (Test Method 4). Stability results are listed in Table 8. One part of the concentrated mixture was diluted with 49 parts water to prepare an application bath. The pH of the application bath was adjusted to 2.0 using Autoacid A-10. Carpet used for this application was light blue nylon 6,6 residential cut-pile carpet. The composition was applied to carpet by an Ahiba exhaust method with 25:1 bath to fiber ratio. The composition was applied to the carpet in a quantity to provide 1.3% on weight of fiber (on a 100% solids basis). The application bath and carpet were brought up to the temperature of 190° F. (88° C.) and held for 20 minutes. Then the sample was rinsed and centrifuged. The carpet was oven cured at 280° F. (138° C.) for 3 minutes.

The carpet sample was tested for stain resistance with Test Method 1. Repellency was evaluated by Test Methods 2 and 3. Results are in Table 8.

### Comparative Example K3

Comparative Example K3 was an untreated carpet of the same substrate that was used to prepare Example 26.

TABLE 8

| | | Coapplication | | | | | |
|---|---|---|---|---|---|---|---|
| | Stain | enhancer 25% | | | | | |
| | Resist | (as 10% | Soil Resist | Stability | | Stain | Water/oil |
| Ex. # | 50% | solution) | 25% | 1 day | 20 days | Resistance | repellency |
| 26 | Stain | p-Toluene | Soil | Stable | Stable | 9 | 4/0 |
| | Resist 3 | sulfonic acid | Resist 2 | | | | |
| K3 | None | None | None | N/A | N/A | 1 | 0/0 |

N/A, not applicable.

As shown in Table 8, the concentrated mixture of Stain Resist 3, a 10% salt solution of p-toluene sulfonic acid, and Soil Resist 2 was stable, and the composition delivered performance benefits of stain resistance and water repellency to the carpet.

### Examples 27-36

Concentrated mixtures were prepared for Examples 27-36 by physically mixing 50% of Stain Resist 2, 25% of a coapplication enhancer solution as listed in Table 9, and 25% of Soil Resist 2. The mixtures were observed for stability after three and five days (Test Method 4). Stability results are listed in Table 9.

### Examples 37-41

Concentrated mixtures were prepared for Example 37-41 by physically mixing 50% of Stain Resist 2, 25% of various concentrations of a coapplication enhancer solution containing sodium sulfate as listed in Table 9, and 25% of Soil Resist 2. The mixtures were observed for stability after three and nine days (Test Method 4). Stability results are listed in Table 9.

TABLE 9

| | | Coapplication | Soil | | |
|---|---|---|---|---|---|
| | Stain Resist | enhancer 25% (as | Resist | Stability | |
| Ex. # | 50% | 10% solution) | 25% | 3 days | 5 days |
| 27 | Stain Resist 2 | Sodium sulfate | Soil | Stable | Stable |
| | | | Resist 2 | | |
| 28 | Stain Resist 2 | p-Toluene sulfonic | Soil | Stable | Stable |
| | | acid | Resist 2 | | |
| 29 | Stain Resist 2 | Sodium xylene | Soil | Stable | Stable |
| | | sulfonate | Resist 2 | | |
| 30 | Stain Resist 2 | Urea | Soil | Stable | Stable |
| | | | Resist 2 | | |
| 31 | Stain Resist 2 | Potassium sulfate | Soil | Stable | Stable |
| | | | Resist 2 | | |
| 32 | Stain Resist 2 | Lithium sulfate | Soil | Stable | Stable |
| | | | Resist 2 | | |
| 33 | Stain Resist 2 | Ammonium sulfate | Soil | Stable | Stable |
| | | | Resist 2 | | |
| 34 | Stain Resist 2 | Sodium sulfite | Soil | Stable | Stable |
| | | | Resist 2 | | |
| 35 | Stain Resist 2 | Dipotassium L- | Soil | Stable | Stable |
| | | tartrate | Resist 2 | | |
| 36 | Stain Resist 2 | Disodium L-tartrate | Soil | Stable | Stable |
| | | | Resist 2 | | |

Examples with diluted coapplication enhancer

| | | Coapplication | | | |
|---|---|---|---|---|---|
| | | enhancer 25% | | | |
| | | (solution | Soil | | |
| | Stain Resist | concentration as | Resist | Stability | |
| Ex. # | 50% | shown) | 25% | 3 days | 9 days |
| 37 | Stain Resist 2 | Sodium sulfate 10% | Soil | Stable | Stable |
| | | | Resist 2 | | |
| 38 | Stain Resist 2 | Sodium sulfate 8% | Soil | Stable | Stable |
| | | | Resist 2 | | |
| 39 | Stain Resist 2 | Sodium sulfate 6% | Soil | Stable | Stable |
| | | | Resist 2 | | |
| 40 | Stain Resist 2 | Sodium sulfate 4% | Soil | Stable | Stable |
| | | | Resist 2 | | |
| 41 | Stain Resist 2 | Sodium sulfate 2% | Soil | Stable | Stable |
| | | | Resist 2 | | |

As shown in Table 9, concentrated mixtures of Stain Resist 2, Soil Resist 2, and 10% coapplication enhancer solutions of sodium sulfate, p-toluene sulfonic acid, sodium xylene sulfonate, urea, potassium sulfate, lithium sulfate, ammonium sulfate, sodium sulfite, dipotassium L-tartrate, disodium L-tartrate, formamide, malonamide, succinimide, and caprolactam respectively were stable. Examples 37-41 demonstrate the stability of different levels of salt concentrations.

### Examples 42-45

Concentrated mixtures were prepared for Examples 42-45 by physically mixing 50% of Stain Resist 2, 25% of a 10% coapplication enhancer solution as listed in Table 10, and 25% of Soil Resist 2. The mixtures were observed for stability after three and five days (Test Method 4). Stability results are listed in Table 10.

### Comparative Example M

A concentrated mixture was prepared for Comparative Example M by physically mixing 66.7% of Stain Resist 2 and 33.3% of Soil Resist 2, but no coapplication enhancer. The mixture was observed for stability after three and five days (Test Method 4). Stability results are listed in Table 10.

TABLE 10

| | | Coapplication | | | |
|---|---|---|---|---|---|
| | | enhancer | | | |
| | Stain Resist | 25% (as | Soil Resist | Stability | |
| Ex. # | 50% | 10% solution) | 25% | 3 days | 5 days |
| 42 | Stain Resist 2 | Succinimide | Soil | Stable | Stable |
| | | | Resist 2 | | |
| 43 | Stain Resist 2 | Malonamide | Soil | Stable | Stable |
| | | | Resist 2 | | |
| 44 | Stain Resist 2 | Caprolactam | Soil | Stable | Stable |
| | | | Resist 2 | | |
| 45 | Stain Resist 2 | Formamide | Soil | Unstable | Stable |
| | | | Resist 2 | | |
| M | Stain Resist 2 | None | Soil | Unstable | Stable |
| | | | Resist 2 | | |

As shown in Table 10, concentrated mixtures of Soil Resist 2; 10% coapplication anhancer solutions of formamide, succinimide, malonamide, and caprolactam; and Stain Resist 2 were stable. Comparative Example M, which contained Stain Resist 2 and Soil Resist 2, with no coapplication enhancer, was not stable.

### Examples 46-59

Concentrated mixtures were prepared for Examples 46-59 by physically mixing 50% of Stain Resist 3, 25% of a 10% coapplication enhancer solution as listed in Table 11, and 25% of Soil Resist 2. The mixtures were observed for stability after three and five days (Test Method 4). Stability results are listed in Table 11.

### Comparative Example N

A concentrated mixture was prepared for Comparative Example N by physically mixing 67.7% of Stain Resist 3, and 33.3% consisting of Soil Resist 2, but no coapplication enhancer. The mixture was observed for stability after three and five days (Test Method 4). Stability results are listed in Table 11.

TABLE 11

| | Stain Resist | Coapplication enhancer | Soil Resist | Stability | |
|---|---|---|---|---|---|
| Ex. # | 50% | 25% (as 10% solution) | 25% | 3 days | 5 days |
| 46 | Stain Resist 3 | Sodium sulfate | Soil | Stable | Stable |
| | | | Resist 2 | | |
| 47 | Stain Resist 3 | p-Toluene sulfonic acid | Soil | Stable | Stable |
| | | | Resist 2 | | |
| 48 | Stain Resist 3 | Sodium xylene sulfonate | Soil | Stable | Stable |
| | | | Resist 2 | | |
| 49 | Stain Resist 3 | Urea | Soil | Stable | Stable |
| | | | Resist 2 | | |
| 50 | Stain Resist 3 | Potassium sulfate | Soil | Stable | Stable |
| | | | Resist 2 | | |
| 51 | Stain Resist 3 | Lithium sulfate | Soil | Stable | Stable |
| | | | Resist 2 | | |
| 52 | Stain Resist 3 | Ammonium sulfate | Soil | Stable | Stable |
| | | | Resist 2 | | |
| 53 | Stain Resist 3 | Sodium sulfite | Soil | Stable | Stable |
| | | | Resist 2 | | |
| 54 | Stain Resist 3 | Dipotassium L-tartrate | Soil | Stable | Stable |
| | | | Resist 2 | | |
| 55 | Stain Resist 3 | Disodium L-tartrate | Soil | Stable | Stable |
| | | | Resist 2 | | |
| 56 | Stain Resist 3 | Monosodium phosphate | Soil | Stable | Stable |
| | | | Resist 2 | | |
| 57 | Stain Resist 3 | Sodium p-toluene | Soil | Stable | Stable |
| | | sulfonate | Resist 2 | | |
| 58 | Stain Resist 3 | Dipotassium phthalate | Soil | Stable | Stable |
| | | | Resist 2 | | |
| 59 | Stain Resist 3 | Phthalic acid | Soil | Stable | Stable |
| | | | Resist 2 | | |
| N | Stain Resist 3 | None | Soil | Unstable | Unstable |
| | | | Resist 2 | | |

As shown in Table 11, concentrated mixtures of Stain Resist 3, Soil Resist 2, and 10% coapplication enhancer solutions of sodium sulfate, p-toluene sulfonic acid, sodium xylene sulfonate, urea, potassium sulfate, lithium sulfate, ammonium sulfate, sodium sulfite, dipotassium L-tartrate, and disodium L-tartrate, monosodium phosphate, sodium para-toluene sulfonic acid, dipotassium phtalate, and phthalic acid respectively were stable. Comparative Example N, which contained Stain Resist 3 and Soil Resist 2, but no coapplication enhancer was not stable. Examples 60-62

Concentrated mixtures were prepared for Examples 60-62 by physically mixing 50% of Stain Resist 4, 25% of a 10% coapplication enhancer solution as listed in Table 12, and 25% of Soil Resist 2. The mixtures were observed for stability after one and twelve days (Test Method 4). Stability results are listed in Table 12.

TABLE 12

| | | Coapplication | | | |
|---|---|---|---|---|---|
| | Stain Resist | enhancer 25% (as | Soil Resist | Stability | |
| Ex. # | 50% | 10% solution) | 25% | 1 day | 12 days |
| 60 | Stain Resist 4 | Succinimide | Soil | Stable | Stable |
| | | | Resist 2 | | |
| 61 | Stain Resist 4 | Malonamide | Soil | Stable | Stable |
| | | | Resist 2 | | |
| 62 | Stain Resist 4 | Formamide | Soil | Stable | Stable |
| | | | Resist 2 | | |

As shown in Table 12, concentrated mixtures of Stain Resist 4; 10% coapplication solutions solutions of formamide, succinimide, and malonamide; and Soil Resist 2 were stable. Examples 63 and 64

Concentrated mixtures were prepared for Examples 63 and 64 by physically mixing 50% of Stain Resist 5, 25% of a 10% coapplication enhancer solution as listed in Table 13, and 25% of Soil Resist 2. The mixtures were observed for stability after one and six days (Test Method 4). Stability results are listed in Table 13.

TABLE 13

| | | Coapplication | Soil | | |
|---|---|---|---|---|---|
| | Stain Resist | enhancer 25% (as | Resist | Stability | |
| Ex. # | 50% | 10% solution) | 25% | 1 day | 6 days |
| 63 | Stain Resist 5 | Sodium sulfate | Soil | Stable | Stable |
| | | | Resist 2 | | |
| 64 | Stain Resist 5 | p-Toluene sulfonic | Soil | Stable | Stable |
| | | acid | Resist 2 | | |

As shown in Table 13, concentrated mixtures of Stain Resist 5, 10% coapplication enhancer solutions of sodium sulfate and p-toluene sulfonic acid, and Soil Resist 2 were stable. Examples 65-67

Concentrated mixtures were prepared for Examples 65-67 by physically mixing 50% of Stain Resist 6, 25% of a 10% coapplication enhancer solution as listed in Table 14, and 25% of Soil Resist 2. The mixtures were observed for stability after one and twelve days (Test Method 4). Stability results are listed in Table 14.

TABLE 14

| | | Coapplication | | | |
|---|---|---|---|---|---|
| | Stain Resist | enhancer 25% (as | Soil Resist | Stability | |
| Ex. # | 50% | 10% solution) | 25% | 1 day | 12 days |
| 65 | Stain Resist 6 | Succinimide | Soil | Stable | Stable |
| | | | Resist 2 | | |
| 66 | Stain Resist 6 | Malonamide | Soil | Stable | Stable |
| | | | Resist 2 | | |
| 67 | Stain Resist 6 | Formamide | Soil | Stable | Stable |
| | | | Resist 2 | | |

As shown in Table 14, concentrated mixtures of Soil Resist 2; 10% coapplication enhancer solutions of formamide, succinimide, and malonamide; and Stain Resist 6, and were stable.

### Examples 68-72

Concentrated mixtures were prepared for Examples 68-72 by physically mixing 50% of Stain Resist 1, 2, or 4; 12.5% of each of two 10% coapplication enhancer solutions as listed in Table 15; and 25% of Soil Resist 1 or 2. The mixtures were observed for stability after one and four days (Test Method 4). Stability results are listed in Table 15. The coapplication enhancer in Examples 68-72 was a combination of equal parts of two coapplication enhancer solutions as listed in Table 15.

TABLE 15

| | Stain | Total Coapplication | | | |
|---|---|---|---|---|---|
| | Resist | enhancer 25% (as | Soil Resist | Stability | |
| Ex. # | 50% | two 10% solutions) | 25% | 1 day | 4 days |
| 68 | Stain | Sodium sulfate | Soil | Stable | Stable |
| | Resist 1 | (12.5%), urea (12.5%) | Resist 1 | | |
| 69 | Stain | Sodium sulfate | Soil | Stable | Stable |
| | Resist 2 | (12.5%), urea (12.5%) | Resist 1 | | |
| 70 | Stain | Sodium sulfate | Soil | Stable | Stable |
| | Resist 1 | (12.5%), urea (12.5%) | Resist 2 | | |
| 71 | Stain | Sodium sulfate | Soil | Stable | Stable |
| | Resist 2 | (12.5%), urea (12.5%) | Resist 2 | | |
| 72 | Stain | Sodium sulfate | Soil | Stable | Stable |
| | Resist 4 | (12.5%), urea (12.5%) | Resist 2 | | |

As shown in Table 15, concentrated mixtures of Examples 68-72 were stable.

### Examples 73-77

Concentrated mixtures were prepared for Examples 73-77 by physically mixing 50% Stain Resist 1, 2 or 4; 12.5% of each of two 10% coapplication enhancer solutions as listed in Table 16; and 25% of Soil Resist 1 or 2. The mixtures were observed for stability after one and four days (Test Method 4). Stability results are listed in Table 16. The coapplication enhancer in Examples 73-77 was a combination of equal parts of two coapplication enhancer solutions as listed in Table 16.

TABLE 16

| | Stain | Total Coapplication | | | |
|---|---|---|---|---|---|
| | Resist | enhancer 25% (as two | Soil Resist | Stability | |
| Ex. # | 50% | 10% solutions) | 25% | 1 day | 4 days |
| 73 | Stain | Sodium acetate | Soil | Stable | Stable |
| | Resist 1 | (12.5%), urea (12.5%) | Resist 1 | | |
| 74 | Stain | Sodium acetate | Soil | Stable | Stable |
| | Resist 2 | (12.5%), urea (12.5%) | Resist 1 | | |
| 75 | Stain | Sodium acetate | Soil | Stable | Stable |
| | Resist 1 | (12.5%), urea (12.5%) | Resist 2 | | |
| 76 | Stain | Sodium acetate | Soil | Stable | Stable |
| | Resist 2 | (12.5%), urea (12.5%) | Resist 2 | | |
| 77 | Stain | Sodium acetate | Soil | Stable | Stable |
| | Resist 4 | (12.5%), urea (12.5%) | Resist 2 | | |

As shown in Table 16, concentrated mixtures of Examples 73-77 were stable.

What is claimed is:

1. A composition comprising a stable mixture of at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof.

2. The composition of claim 1 wherein the coapplication enhancer is aryl sulfonate, acetamide, dimethylacetamide, formamide, dimethylformamide, caprolactam, malonamide, malonimide, succinamide, or succinimide.

3. The composition of claim 1 wherein the coapplication enhancer is a salt, said salt is a cation in combination with an anion, said anion selected from the group consisting of sulfate, sulfonate, sulfite, phosphate, borate, chloride, polyphosphate, nitrate, acetate, citrate, benzoate, tetrafluoroborate, tartrate, phthalate, and mono and dialkyl phosphate.

4. The composition of claim 1 wherein the coapplication enhancer is sodium sulfate, potassium sulfate, sodium aryl sulfonate, potassium aryl sulfonate, sodium phosphate, trisodium phosphate, or toluene sulfonic acid.

5. The composition of claim 1 wherein the stain resist agent comprises a sulfonated phenolic resin or condensate; a partially sulfonated novalac resin; a polymer or copolymer of acrylic acid, methacrylic acid or esters thereof; a hydrolyzed copolymer of maleic anhydride with olefin or vinyl ether; a hydrolyzed ethylenically unsaturated aromatic/maleic anhydride copolymer; and combinations thereof.

6. The composition of claim 5 wherein the stain resist agent is a mixture of hydrolyzed maleic anhydride copolymer and a sulfonated phenolic resin or a mixture of a hydrolyzed octene/maleic anhydride copolymer and a sulfonated phenolic resin.

7. The composition of claim 1 wherein the soil resist agent comprises a fluorinated polyurethane, a polymer or copolymer containing a fluorinated acrylate, or a polymer or copolymer containing a fluorinated methacrylate.

8. The composition of claim 1 wherein the soil resist agent contains a perfluoroalkyl group of the following formula R_{f}(CH₂)ₙ-wherein R_{f} is a straight or branched perfluoroalkyl wherein n is an integer of from 1 to about 20, or a mixture thereof, wherein the perfluoroalkyl is optionally interrupted by at least one oxygen atom.

9. The composition of claim 8 wherein n is an integer of from about 4 to about 10.

10. The composition of claim 1 wherein the ratio of coapplication enhancer to a combination of stain resist agent and soil resist agent is from about 1:4 to about 1:52 on a 100% solids weight basis.

11. The composition of claim 1 further comprising a compound or composition that provides a surface effect selected from the group consisting of no iron, easy to iron, shrinkage control, wrinkle free, permanent press, moisture control, softness, strength, anti-slip, anti-static, anti-snag, anti-pill, stain repellency, stain release, odor control, antimicrobial, and sun protection.

12. The composition of claim 1 further comprising surfactants, sequestering agents, leveling agents, pH adjusters, cross linkers, wetting agents, blocked isocyanates, hydrocarbon extenders, and wax extenders.

13. The composition of claim 1 in the form of a solution or dispersion, or a combination thereof.

14. A method for providing stain resistance and soil resistance to substrates comprising contacting the substrate with a single medium containing a stable mixture comprising at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof.

15. The method of claim 14 wherein the contacting comprises use of exhaustion, Flex-nip, pad, spray, or foam application.

16. The method of claim 14 wherein the ratio of coapplication enhancer to a combination of stain resist agent and soil resist agent is from about 1:4 to about 1:52 on a 100% solids weight basis.

17. The method of claim 14 wherein the amount of coapplication enhancer present in the medium is from about 0.05 g/L to about 2 g/L.

18. The method of claim 14 wherein the amount of mixture contacting the substrate is from about 0.1 to about 5 percent solids on weight of fiber.

19. The method of claim 14 wherein the enhancer is sodium sulfate, potassium sulfate, sodium aryl sulfonate, potassium aryl sulfonate, sodium phosphate, trisodium phosphate, or toluene sulfonic acid.

20. The method of claim 14 wherein the stain resist agent comprises a sulfonated phenolic resin or condensate, a partially sulfonated novalac resin, a polymer or copolymer of methacrylic acid or esters thereof, a hydrolyzed copolymer of maleic anhydride with olefin or vinyl ether, a hydrolyzed ethylenically unsaturated aromatic/maleic anhydride copolymer, and combinations thereof.

21. The method of claim 14 wherein the soil resist agent is a fluorinated polyurethane, a polymer or copolymer containing a fluorinated acrylate, or a polymer or copolymer containing a fluorinated methacrylate.

22. The method of claim 21 wherein the soil resist agent contains a perfluoroalkyl group of the following formula R_{f}(CH₂)ₙ-wherein R_{f} is a straight or branched perfluoroalkyl wherein n is an integer of 1 to about 20, or a mixture thereof, wherein the perfluoroalkyl is optionally interrupted by at least one oxygen atom.

23. A substrate to which has been applied from a single medium a composition comprising a stable mixture of at least one stain resist agent, at least one soil resist agent, and at least one coapplication enhancer, said enhancer comprising at least one of an alkali metal salt; alkali metal aryl salt; ammonium salt; ammonium aryl salt; aryl sulfonic acid; urea; amide; alkylamide; dialkylamide; amide of C₁ to C₆ alkanoic acids or of C₂ to C₆ alkandioic acids; diamides of C₂ to C₆ alkandioic acids; cyclic imide of C₂ to C₆ alkandioic acids; C₃ to C₆ lactams, or combinations thereof.

24. The substrate of claim 23 comprising a fibrous substrate.

25. The substrate of claim 23 which is a fiber, yam, fabric, fabric blend, carpet, textile, nonwoven, leather or paper.

26. The substrate of claim 25 which is carpet.
